(19) United States
(12) Patent Application Publication
(10) Pub. No.: US 2016/0163423 A1
(43) Pub. Date: Jun. 9, 2016

(54) SHIELDED WIRE AND WIRE HARNESS

(71) Applicant: Yazaki Corporation, Tokyo (JP)

(72) Inventors: Yusuke YANAGIHARA, Kakegawa-shi (JP); Shigeo MORI, Kakegawa-shi (JP); Junya HIGASHI, Kakegawa-shi (JP); Takashi ISHIHARA, Kakegawa-shi (JP)

(73) Assignee: Yazaki Corporation, Tokyo (JP)

(21) Appl. No.: 15/007,359

(22) Filed: Jan. 27, 2016

Related U.S. Application Data
(63) Continuation of application No. PCT/JP2014/072335, filed on Aug. 26, 2014.

(30) Foreign Application Priority Data
Aug. 26, 2013 (JP) 2013-174183

(51) Int. Cl. H01B 11/18; H01B 7/00

(52) U.S. Cl. CPC H01B 11/1817; H01B 7/0045; H01B 7/0018

(57) ABSTRACT

A wire harness includes a surface treated shielded wire and a counterpart connection portion provided at an end of the surface treated shielded wire. The surface treated shielded wire includes a conductor, an insulative coating provided on an outer side of the conductor, an electrically-conductive surface treatment portion applied on a surface of the insulative coating from one end to the other end, in an extending direction of the conductor, of a predetermined range on the insulative coating, and a metal wire having electrical conductivity.

### CROSS REFERENCE TO RELATED APPLICATIONS

This application is a continuation of International Patent Application No. PCT/JP2014/072335 filed on Aug. 26, 2014, claiming priority from Japanese Patent Application No. 2013-174183 filed on Aug. 26, 2013, the contents of which are incorporated herein by reference.

### FIELD OF INVENTION

The present invention relates to a wire harness, and in particular, to a shielded wire for use in the wire harness.

### BACKGROUND ART

Known shielded wires include those using a braided wire as a shielding member and those using a shielding layer formed by resin plating (see, e.g., JP2012-138280A). A wire harness using such shielded wires will be described briefly below.

In FIG. 6, the reference sign 101 represents a high voltage wire harness to be mounted on a vehicle. The wire harness 101 has a configuration including three surface treated shielded wires 102, and shielded connector 103 provided at respective ends of the surface-treated shielded wires 102.

Each surface treated shielded wire 102 has a configuration including a conductor 104, an insulative coating 105 and an electrically-conductive surface treatment portion 106. A metal plate having electrical conductivity and formed into a belt-like shape is used as the conductor 104. That is, a metal plate like a bus bar is used. Since the conductor 104 is formed into a shape like a bus bar as described above, it is a matter of course that the conductor 104 has rigidity. In addition, when the conductor 104 is bent, the conductor 104 can keep the bent shape.

The insulative coating 105 is an insulator provided on an outer side of the conductor 104. The insulative coating 105 is formed by extrusion molding out of a resin material having an insulating property. The surface (external surface) of the insulative coating 105 configured thus is formed into a flat surface.

The electrically-conductive surface treatment portion 106 is formed as a shielding layer on the surface of the insulative coating 105 by resin plating for applying plating to a surface of a molded article formed out of a synthetic resin material. The electrically-conductive surface treatment portion 106 is formed in tight contact with the surface of the insulative coating 105. In addition, the electrically-conductive surface treatment portion 106 is formed with a predetermined thickness. The electrically-conductive surface treatment portion 106 is formed as a portion for shielding the insulative coating 105 over a predetermined range. The entire electrically-conductive surface treatment portion 106 has electrical conductivity.

Each shielded connector 103 is used as a portion to be electrically connected to a device 107. The shielded connector 103 has a configuration including a terminal 108, a seal member 109 and a shield shell 110. The insulative coating 105 at a end of the surface treated shielded wire 102 is removed by a predetermined length to from the terminal 108. The terminal 108 is formed into a tab-like shape. The terminal 108 formed thus is connected to a counterpart terminal 111 of the device 107.

The device 107 includes a shield case 112 having electrical conductivity, in addition to the aforementioned counterpart terminal 111. A through hole 113 is formed in the shield case 112 so that the end of the surface treated shielded wire 102 can be plugged into the through hole 113.

The seal member 109 is a rubber member having electrical conductivity. The seal member 109 is formed so that the end of the surface treated shielded wire 102 can penetrate the seal member 109. In addition, the seal member 109 is formed in tight contact with the surface treated shielded wire 102 so that electric conduction can be secured between the seal member 109 and the electrically-conductive surface treatment portion 106. Further, the seal member 109 is formed in tight contact with the shield case 112 so that moisture etc. can be prevented from invading the shield case 112 through the through hole 113. Furthermore, the seal member 109 is formed so that the seal member 109 can hold the shield shell 110 and electric conduction can be secured between the seal member 109 and the shield shell 110.

The shield shell 110 is a member formed by processing out of a metal plate having electrical conductivity. The shield shell 110 is formed into an annular shape so that the shield shell 110 attached to the seal member 109 can contact with the external surface of the shield case 112. The shield shell 110 is screwed down to the shield shell 112 so as to be fixed thereto.

In the aforementioned configuration and structure, the wire harness 101 is fabricated into a shape intended to be placed in a predetermined wiring path on a vehicle in order to electrically connect the device 107 and a not-shown device, for example, in order to electrically connect an inverter unit and a motor unit. The reference sign 114 represents a bent portion formed at a predetermined place where the surface treated shielded wire 102 is bent in the wire harness 101.

However, the conventional art described above has the following problems.

That is, the thermal expansion coefficient of the insulative coating 105 made of synthetic resin is higher than that of the electrically-conductive surface treatment portion 106 (resin plating). Accordingly, when the deformation of the electrically-conductive surface treatment portion 106 cannot follow the deformation of the insulative coating 105, the electrically-conductive surface treatment portion 106 is wrinkled. When the insulative coating 105 is thermally expanded and contracted repeatedly, the electrically-conductive surface treatment portion 106 is cracked in the wrinkled portion. Such a partial crack in the electrically-conductive surface treatment portion 106 causes deterioration in shield performance. Further, when the electrically-conductive surface treatment portion 106 is broken entirely circumferentially around the insulative coating 105, the shield performance may deteriorate extremely.

The shield performance may also deteriorate due to the following factor. That is, a metal layer formed by resin plating is hardly deformed due to an external force acting thereon, as compared with the insulative coating 105 serving as an underlayer. Therefore, when sudden bending or excessive bending is applied on the surface treated shielded wire 102 or when the surface treated shielded wire 102 is exposed to mechanical stress such as vibration, a large crack or breakage occurs in the electrically-conductive surface treatment portion 106. Such a crack in the electrically-conductive surface treatment portion 106 also causes deterioration in shield performance.

### SUMMARY OF INVENTION

Illustrative aspects of the present invention provides a shielded wire and a wire harness capable of maintaining shield performance, even when a crack occurs in an electrically-conductive surface treatment portion.

According to an illustrative aspect of the present invention, a shielded wire includes a conductor, an insulative coating provided on an outer side of the conductor, an electrically-conductive surface treatment portion applied on a surface of the insulative coating from one end to another end, in an extending direction of the conductor, of a predetermined range on the insulative coating, and an electrically-conductive member having electrical conductivity and electrically connected to the electrically-conductive surface treatment portion.

According to these features, a conduction path is secured by the electrically-conductive member contacting the electrically-conductive surface treatment portion even when the electrically-conductive surface treatment portion is cracked. According to the present invention, it is therefore possible to maintain the shield performance.

The electrically-conductive member may be provided at a location corresponding to a bent portion of the shielded wire.

According to these features, a conduction path is secured by the electrically-conductive member in contact with the electrically-conductive surface treatment portion even when the electrically-conductive surface treatment portion is cracked, for example, due to stress applied thereto during bending. According to the present invention, it is therefore possible to maintain the shield performance.

The electrically-conductive member may include at least one of a wire and a tape having electrical conductivity.

According to these features, a conduction path is secured by the wire and/or the tape having electrical conductivity even when the electrically-conductive surface treatment portion is cracked.

The wire may be wound spirally.

According to these features, contact (contact pressure) between the wire and the electrically-conductive surface treatment portion is secured during bending. It is therefore possible to prevent the wire from easily leaving the electrically-conductive surface treatment portion when the shielded wire is bent. For example, when the wire is provided straightly in the direction of the wire axis, looseness may occur easily in the wire on the inner side of the bent portion of the shielded wire, so that the wire can leave the electrically-conductive surface treatment portion. According to the present invention, however, it is possible to prevent such a trouble from easily occurring.

According to another illustrative aspect of the present invention, a wire harness includes the shielded wire described above, and a counterpart connection portion provided at an end of the shielded wire, the counterpart connection portion being electrically connected to the electrically-conductive surface treatment portion.

According to these features, it is possible to make electric connection between devices, and it is also possible to maintain shield performance between devices.

According to the illustrative aspects of the present invention, there is an advantage that it is possible to secure a conduction path from one axial end thereof to the other end in a range to be shielded. According to the present invention, there is an advantage that it is therefore possible to maintain shield performance.

### BRIEF DESCRIPTION OF THE DRAWINGS

FIG. 1A includes a diagram of a straight portion of a wire harness and an external view of a surface treated shielded wire according to the present invention (Embodiment 1);

FIG. 1B includes a diagram of a bent portion of the wire harness and an external view of the surface treated shielded wire according to the present invention (Embodiment 1);

FIG. 2 is a sectional view of a terminal portion of the wire harness;

FIG. 3 includes a diagram of a wire harness and an external view of a surface treated shielded wire according to the present invention (Embodiment 2);

FIG. 4 includes a diagram of a wire harness and an external view of a surface treated shielded wire according to the present invention (Embodiment 3);

FIG. 5 is a diagram illustrating a location where a wire harness according to the present invention is arranged in a vehicle (Embodiment 4); and

FIG. 6 is a sectional view of a conventional wire harness.

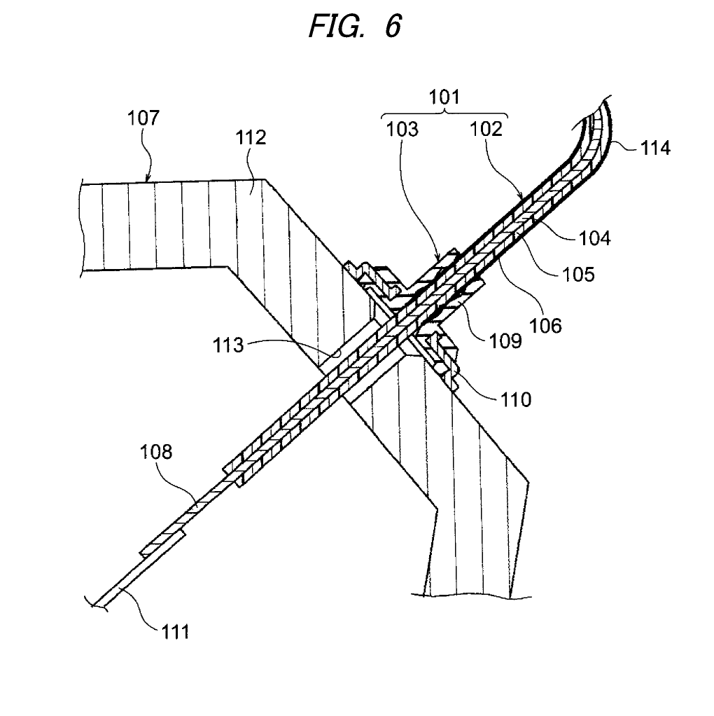

### EMBODIMENTS OF INVENTION

A wire harness has a configuration including a surface treated shielded wire and counterpart connection portion provided at an end of the surface treated shielded wire. The surface treated shielded wire includes a conductor, an insulative coating provided on an outer side of the conductor, an electrically-conductive surface treatment portion applied on a surface of the insulative coating from one end to the other end, in an extending direction of the conductor, of a predetermined range on the insulative coating, and an electrically-conductive member having electrical conductivity that is in contact with the electrically-conductive surface treatment portion.

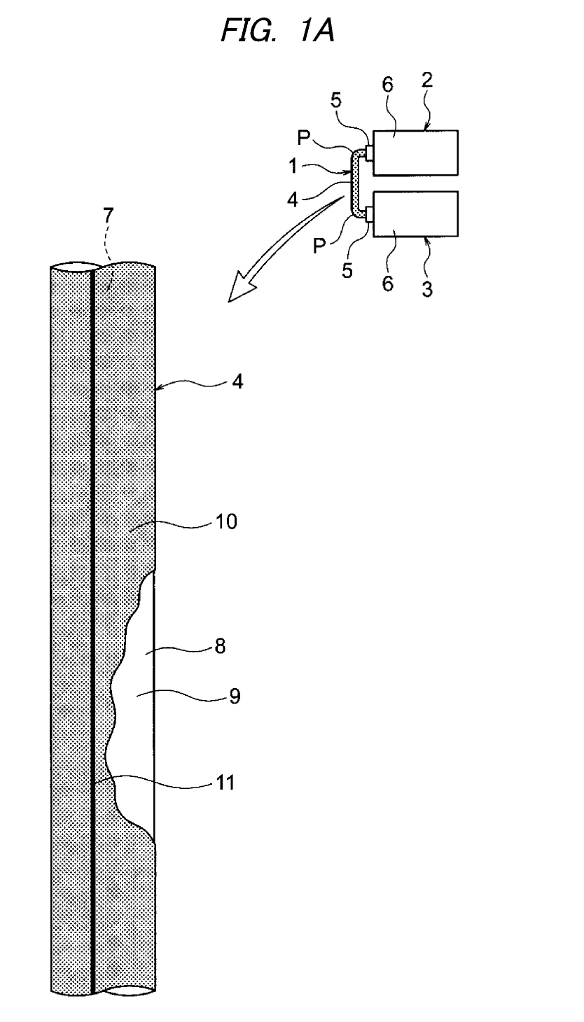

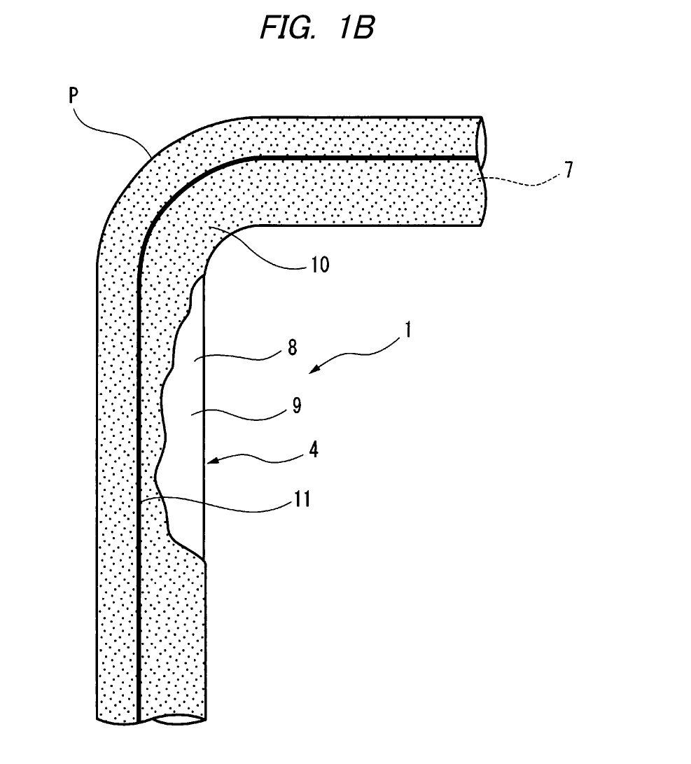

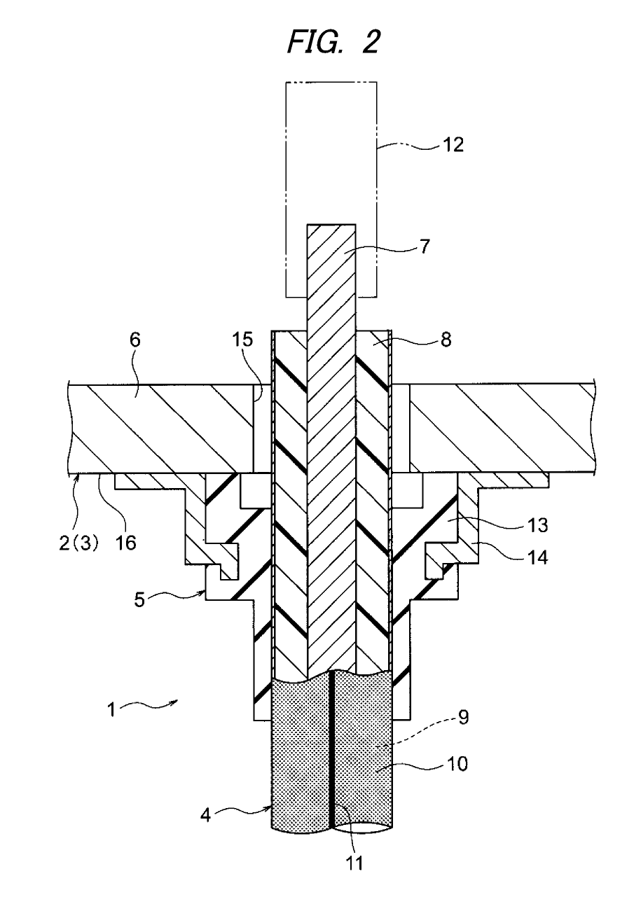

Embodiment 1 will be described below with reference to the drawings. FIG. 1A includes a diagram of a straight portion of a wire harness according to the present invention, and an external view of a surface treated shielded wire. FIG. 1B includes a diagram of a bent portion of the wire harness according to the present invention, and an external view of the surface treated shielded wire. In addition, FIG. 2 is a sectional view of a terminal portion of the wire harness.

In FIG. 1A and FIG. 1B, the reference sign 1 represents a wire harness. The wire harness 1 is a high voltage wire harness for use in an electric car or a hybrid car. The wire harness 1 serves for electrically connecting a high voltage device 2 and a high voltage device 3. However, the wire harness is not limited to such a high voltage one but may be a low voltage one. The wire harness 1 has a configuration including one or plural surface treated shielded wires 4, and counterpart connection portions 5, 5 provided at ends of each surface treated shielded wire 4. The wire harness 1 has shield performance by virtue of the surface treated shielded wires 4. The wire harness 1 is electrically connected to shield cases 6, 6 of the respective high voltage device 2, 3. The wire harness 1 is formed so that the wire harness 1 can be wired in a predetermined path between the high voltage device 2, 3.

In FIG. 1A to FIG. 2, each surface treated shielded wire 4 has a configuration including a conductor 7, an insulative coating 8 (insulator) provided on an outer side of the conductor 7, an electrically-conductive surface treatment portion 10 that is applied to a surface 9 of the insulative coating 8 so as to shield a predetermined range (e.g., a range covering the entire length) in the extending direction of the conductor 7, and a metal wire 11 (electrically-conductive member) that is electrically connected to the electrically-conductive surface treatment portion 10. The surface treated shielded wire 4 is formed into a sectionally circular shape in the embodiment. The sectional shape is exemplary. The sectional shape of the surface treated shielded wire 4 may be a rectangular shape as that in conventional examples.

At each end of the surface treated shielded wire 4, the insulative coating 8 is removed by a predetermined length and processed to expose the conductor 7 having electrical conductivity. That is, the terminal is processed so that it can be connected to a terminal 12, which will be described later. The conductor 7 is made of aluminum, an aluminum alloy, copper or a copper alloy. Here, a conductor structure serving as a twisted wire is used. The conductor structure is exemplary. Specifically, the conductor 7 may have a rod-like conductor structure that is rectangular or circular in section. That is, the conductor 7 may have a conductor structure that serves as a rectangular single core or a circular single core. Alternatively, the conductor 7 may be a bus bar or the like.

The insulative coating 8 is formed out of a resin material having an insulating property and extruded to the outside of the conductor 7. Examples of the resin material may include polyethylene based resin, polypropylene based resin, polyvinylchloride resin, etc. The resin material is not limited especially only if it can apply the electrically-conductive surface treatment portion 10 to the surface 9 of the insulative coating 8. Since the insulative coating 8 is formed into a cylindrical shape, the sectional shape of the surface treated shielded wire 4 is circular. In FIG. 1A and FIG. 1B, while the surface 9 is actually covered with the electrically-conductive surface treatment portion 10, the surface 9 is illustrated in a partially removed manner for the convenience of explanation. The same applies to other embodiments that will be described later.

The electrically-conductive surface treatment portion 10 is an electrically-conductive surface treatment portion, and in the this embodiment, is configured as a shielding layer by resin plating in a similar manner as in conventional examples. Examples of the conductive surface treatment may include conductive painting, vapor deposition, etc. in addition to the treatment described above.

The electrically-conductive surface treatment portion 10 is formed along the entire length of the surface treated shielded wire 4. That is, in the embodiment, the electrically-conductive surface treatment portion 10 is formed by surface treatment applied all over the surface 9 of the insulative coating 8. The electrically-conductive surface treatment portion 10 may be applied to the whole surface of a range that has to be shielded. The electrically-conductive surface treatment portion 10 is formed to be as thick as that in conventional examples. The electrically-conductive surface treatment portion 10 may be formed out of a plurality of layers including an underlayer plating.

The electrically-conductive surface treatment portion 10 is a shielding member reduced in weight, as compared with a braided wire for use in a shielded wire.

The metal wire 11 is a wire having electrical conductivity. The metal wire 11 is fixed to the surface (and/or the back) of the electrically-conductive surface treatment portion 10 so that electric connection with the electrically-conductive surface treatment portion 10 can be secured. In the embodiment, the metal wire 11 is fixed so as to be pasted to the electrically-conductive surface treatment portion 10 at a plurality of places. When the metal wire 11 is pasted, a bonding agent may be applied to the electrically-conductive surface treatment portion 10 or a bonding agent may be applied to the metal wire 11. In addition, the metal wire 11 may be fixed in such a manner that a well-known tape or the like may be pasted to the electrically-conductive surface treatment portion 10 so as to put the metal wire 11 between the tape and the electrically-conductive surface treatment portion 10. A synthetic resin material or the like containing electrically conductive material may be used as the bonding agent. The invention is not limited to any specific manner as long as it can fix the metal wire 11 to the electrically-conductive surface treatment portion 10 so that electric connection to the electrically-conductive surface treatment portion 10 can be secured.

The metal wire 11 is provided in parallel with the wire axis. In addition, the metal wire 11 is provided along the entire length of the surface treated shielded wire 4. The metal wire 11 may be provided at least at a location corresponding to the bent portion of the surface treated shielded wire 4 t (see FIG. 1B, hereinafter referred to as a wire bent portion P). When the metal wire 11 is provided all over the length as in the embodiment, it is a matter of course that processing can be made easier.

The metal wire 11 is provided as a member by which a conduction path can be secured from one axial end to the other end in a range to be shielded even if the electrically-conductive surface treatment portion 10 is cracked. The number of metal wires 11 is not limited to one as illustrated, but a plurality of metal wires 11 may be provided.

Each counterpart connection portion 5 is a shielded connector similar to that in conventional examples. The counterpart connection portion 5 serves as a portion to be electrically connected to the high voltage device 2, 3. The counterpart connection portion 5 has a configuration including a terminal 12, a seal member 13 and a shield shell 14 as shown in FIG. 2.

The terminal 12 is connected to the conductor 7 exposed at a end of the surface treated shielded wire 4. A suitable method such as crimping, pressure contact, fusion, welding, etc. may be used as a method for the connection. The terminal 12 plugged into a through hole 15 of the shield case 6 is electrically connected and fixed to a not-shown counterpart terminal.

The seal member 13 is a member having electrical conductivity and made of rubber. The seal member 13 is formed so that a end of the surface treated shielded wire 4 can penetrate the seal member 13. In addition, the seal member 13 is formed so that the seal member 13 can tightly contact with the surface treated shielded wire 4 so as to secure electric conduction with the electrically-conductive surface treatment portion 10.

Further, the seal member 13 is formed so that the seal member 13 can tightly contact with the shield case 6 so as to prevent moisture etc. from invading the shield case 6 through the through hole 15. Furthermore, the seal member 13 is formed so that the seal member 13 can hold the shield case 14 to secure electric conduction with the shield shell 14.

The shield shell 14 is a member formed out of a metal plate having electrical conductivity by press working. The shield shell 14 is formed into an annular shape that can touch an external surface 16 of the shield case 6 when the shield shell 14 has been attached to the seal member 13. The shield shell 14 is screwed down and fixed to the shield case 6 (with a not-shown screwing portion). On the other hand, the shield shell 14 is intended to secure conduction with the electrically-conductive surface treatment portion 10 of the surface treated shielded wire 4.

In the aforementioned configuration and structure, a conduction path can be secured by the metal wire 11 electrically connected to the surface of the electrically-conductive surface treatment portion 10 even if the electrically-conductive surface treatment portion 10 is cracked due to stress applied on the surface treated shielded wire 4, for example, during bending when the wire harness 1 is wired in a predetermined path. It is therefore possible to maintain the shield performance.

As has been described above with reference to FIG. 1A to FIG. 2, a conduction path can be secured by the metal wire 11 even if the electrically-conductive surface treatment portion 10 is cracked or broken. Accordingly, there is an advantage that the surface treated shielded wire 4 can secure shield performance with a simple configuration and a simple structure. In addition, since the wire harness 1 has a configuration including the surface treated shielded wire 4, there is an advantage that it is possible to secure electric connection between the high voltage device 2, 3 while maintaining the shield performance. The wire harness 1 also has an advantage that high reliability can be obtained.

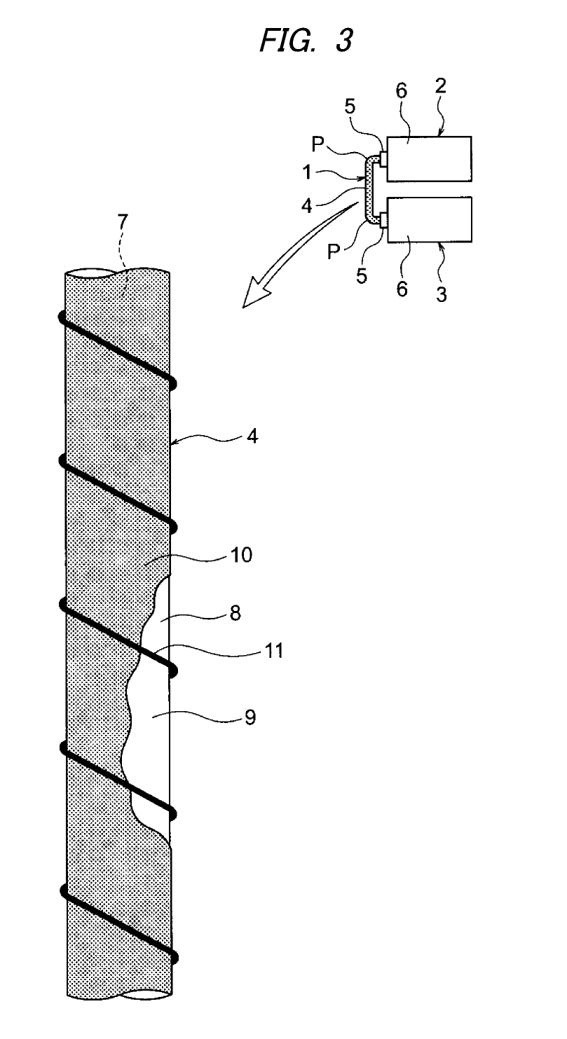

Embodiment 2 will be described below with reference to the drawings. FIG. 3 includes a diagram of a wire harness according to the present invention, and an external view of a surface treated shielded wire. Components that are basically the same as those of Embodiment 1 denoted by the same reference signs, and detailed description thereof will be omitted. In FIG. 3, while the surface 9 is actually covered with the electrically-conductive surface treatment portion 10, the surface 9 is illustrated in a partially removed manner for the convenience of explanation.

In FIG. 3, in the wire harness 1 according to Embodiment 2, the arrangement of the metal wire 11 is changed from that in the wire harness 1 in Embodiment 1. That is, the metal wire 11 is wound on the surface side (and/or the back side) of the electrically-conductive surface treatment portion 10 spirally along the axis of the insulative coating 8, and fixed to the electrically-conductive surface treatment portion 10 in an adhered manner. The metal wire 11 configured thus is provided along the entire length of the surface treated shielded wire 4. The number of metal wires 11 is not limited to one as illustrated, but a plurality of metal wires 11 may be provided. Specifically, (1) two or three metal wires 11 may be, for example, bundled and wound spirally, or (2) four metal wires 11 may be, for example, prepared and wound spirally to be disposed at an equal pitch of 90 degrees.

As has been described above with reference to FIG. 3, in the wire harness 1 according to Embodiment 2, the arrangement of the metal wire 11 is changed from that in Embodiment 1. Accordingly, in the same manner as in Embodiment 1, there is an advantage that the shield performance can be maintained with a simple configuration and a simple structure, and there is an advantage that the reliability can be improved.

Not to say, the aforementioned reliability can be obtained even in the embodiment in which the metal wire 11 is wound spirally. Specifically, assume that the metal wire 11 is fixed to the inside of a bent portion of the surface treated shielded wire 4 in Embodiment 1. In this case, looseness may occur in the metal wire 11 when the surface treated shielded wire 4 is bent. Thus, there is a fear that the metal wire 11 may leave the electrically-conductive surface treatment portion 10. On the other hand, when the metal wire 11 is wound spirally as in Embodiment 2, contact (contact pressure) between the metal wire 11 and the electrically-conductive surface treatment portion 10 can be secured even if the surface treated shielded wire 4 is bent. Thus, such a trouble that the metal wire 11 may leave the electrically-conductive surface treatment portion 10 can be prevented from occurring easily. Accordingly, there is an advantage that the reliability of the wire harness 1 can be improved.

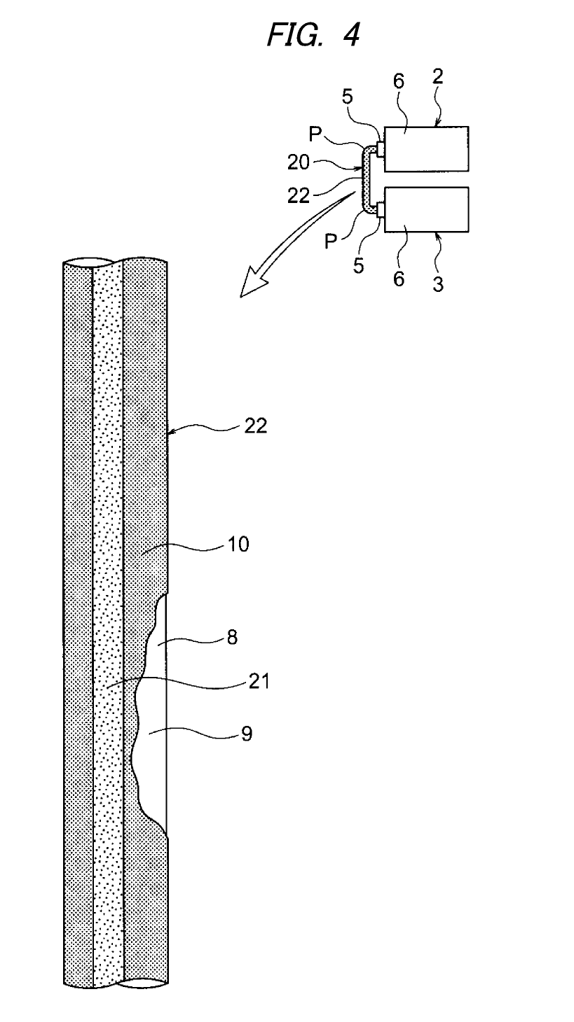

Embodiment 3 will be described below with reference to the drawings. FIG. 4 includes a diagram of a wire harness according to the present invention, and an external view of a surface treated shielded wire. Components that are basically the same as those of Embodiment 1 denoted by the same reference signs, and detailed description thereof will be omitted. In FIG. 4, while the surface 9 is actually covered with the electrically-conductive surface treatment portion 10, the surface 9 is illustrated in a partially removed manner for the convenience of explanation.

In FIG. 4, in a wire harness 20 according to Embodiment 3, the surface treated shielded wire in the wire harness 1 according to Embodiment 1 is replaced by a surface treated shielded wire 22 including an electrically-conductive tape 21. That is, the wire harness 20 has a configuration including one or plural surface treated shielded wires 22 each having an electrically-conductive tape 21, and counterpart connection portions 5, 5 provided at ends of each surface treated shielded wire 22.

The wire harness 20 is formed and shaped so that the wire harness 20 can be wired in a predetermined path between the high voltage device 2, 3. The wire harness 20 has shield performance, and is electrically connected to shield cases 6, 6 of the respective high voltage device 2, 3.

Each surface treated shielded wire 22 has a configuration including a conductor 7 (see FIG. 2. The same thing can be applied to the following members), an insulative coating 8 (insulator) provided on an outer side of the conductor 7, an electrically-conductive surface treatment portion 10 that is applied to a surface 9 of the insulative coating 8 so as to shield a predetermined range (e.g., a range covering the entire length), and an electrically-conductive tape 21 (electrically-conductive member) that electrically contacts with the electrically-conductive surface treatment portion 10.

At each end of the surface treated shielded wire 22, the insulative coating 8 is removed by a predetermined length and processed to expose the conductor 7 having electrical conductivity, in the same manner as in Embodiment 1. That is, the terminal is processed so that it can be connected to a terminal 12 (see FIG. 2). The insulative coating 8 is formed out of a resin material having an insulating property and extruded to the outside of the conductor 7.

The electrically-conductive surface treatment portion 10 is an electrically-conductive surface treatment portion applied on the surface 9 of the insulative coating 8. In the embodiment, the electrically-conductive surface treatment portion 10 is formed in the same manner as in Embodiment 1.

The electrically-conductive tape 21 is a tape having electrical conductivity and having a predetermined width. The electrically-conductive tape 21 is provided to be pasted to the surface (and/or the back) of the electrically-conductive surface treatment portion 10. The electrically-conductive tape 21 is provided straightly along the wire axis. In addition, the electrically-conductive tape 21 is provided along the entire length of the surface treated shielded wire 22. The electrically-conductive tape 21 may be provided in at least a position corresponding to a wire bent portion P. When the electrically-conductive tape 21 is provided all over the length as in the embodiment, it is a matter of course that processing can be made easier.

The electrically-conductive tape 21 is provided as a member by which a conduction path can be secured from one axial end to the other end in a range to be shielded even if the electrically-conductive surface treatment portion 10 is cracked. The number of electrically-conductive tapes 21 is not limited to one as illustrated, but a plurality of electrically-conductive tapes 21 may be provided. In addition, the electrically-conductive tape 21 may be wound spirally.

In the aforementioned configuration and structure, a conduction path can be secured by the electrically-conductive tape 21 in electric contact with the surface of the electrically-conductive surface treatment portion 10 even if the electrically-conductive surface treatment portion 10 is cracked due to stress applied on the surface treated shielded wire 22, for example, during bending when the wire harness 1 is wired in a predetermined path. It is therefore possible to maintain the shield performance.

Accordingly, it is a matter of course that the wire harness 20 according to Embodiment 3 also has an advantage similar to that in Embodiment 1.

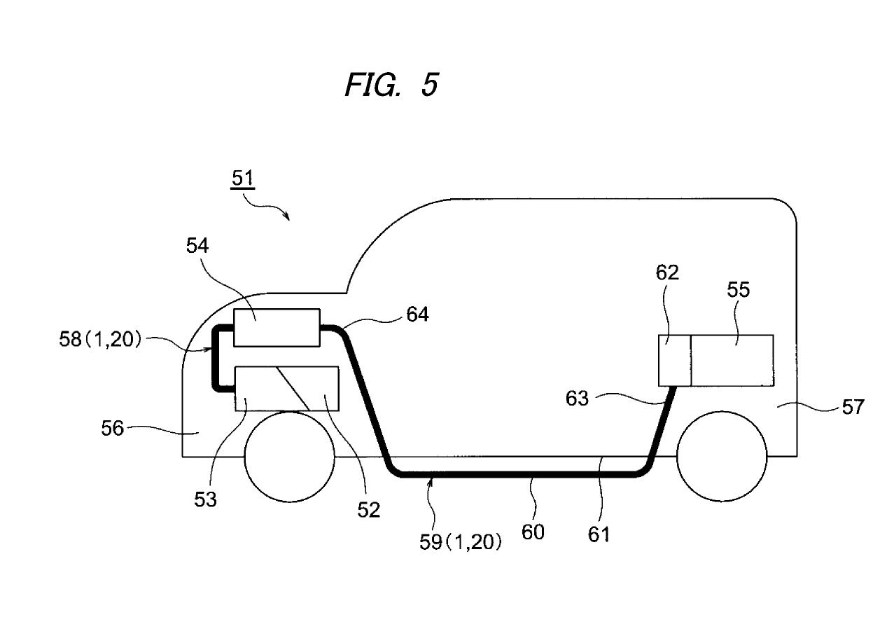

Embodiment 4 will be described below with reference to the drawings. FIG. 5 is a diagram illustrating a location where a wire harness according to the present invention is arranged in a vehicle.

In FIG. 5, the reference sign 51 represents a hybrid car (which may be replaced by an electric car or an ordinary car). The hybrid car 51 is a vehicle that is driven by a mixture of two power sources, that is, an engine 52 and a motor unit 53. To the motor unit 53, electric power is supplied from a battery 55 (battery pack) through an inverter unit 54. In this embodiment, the engine 52, the motor unit 53 and the inverter unit 54 are mounted in an engine room 56 located in a site where there are front wheels etc. On the other hand, the battery 55 is mounted in a car rear portion 57 located in a site where there are rear wheels etc. The battery 55 may be mounted in a car cabin that is located at the rear of the engine room 56.

The motor unit 53 and the inverter unit 54, which are high voltage device, are connected through a high voltage wire harness 58 (motor cable). In addition, the battery 55 and the inverter unit 54 are also connected through a high voltage wire harness 59. One of the wire harnesses 1 and 20 according to Embodiment 1 to Embodiment 4 is used as each wire harness 58, 59.

Three surface treated shielded wires 4 (22) are used for the wire harness 58, whereas two surface treated shielded wires 4 (22) are used for the wire harness 59. In addition, an exterior member or the like for covering the surface treated shielded wires 4 (22) in a lump is used in accordance with necessity.

An intermediate portion 60 of the wire harness 59 is wired in an vehicle underfloor 61. In addition, the wire harness 59 is wired substantially in parallel with the vehicle underfloor 61. The wire harness 59 and the battery 55 are connected through a junction block 62 that is provided in the battery 55. A rear end 63 of the wire harness 59 is electrically connected to the junction block 62 by a well-known method (e.g., using the counterpart connection portion 5 in FIG. 2). On the other hand, a front end 64 of the wire harness 59 is electrically connected to the inverter unit 54 in the same manner.

Further, it is a matter of course that various changes may be made to implement the present invention without changing the gist of the invention.

Here, some features of the shielded wires and the wire harnesses according to the aforementioned embodiments of the present invention will be summarized briefly and listed in the following [1] to [5].

[1] A shielded wire (surface treated shielded wire 4) including:

a conductor (7);

an insulative coating (8) provided on an outer side of the conductor;

an electrically-conductive surface treatment portion (10) applied on a surface of the insulative coating from one end to another end, in an extending direction of the conductor, of a predetermined range on the insulative coating; and

an electrically-conductive member (metal wire 11) having electrical conductivity and electrically connected to the electrically-conductive surface treatment portion.

[2] The shielded wire according to [1] described above, wherein the electrically-conductive member is provided at a location corresponding to a bent portion (wire bent portion P) of the shielded wire.
[3] The shielded wire according to [2] described above, wherein a wire and/or a tape having electrical conductivity is used as the electrically-conductive member.
[4] The shielded wire according to [3] described above, wherein the wire is wound spirally.
[5] A wire harness (1) including:

the shielded wire according to any one of [1] to [4] described above; and

a counterpart connection portion (5) provided at an end of the shielded wire, the counterpart connection portion being electrically connected to the electrically-conductive surface treatment portion.

While the present invention has been described in detail with reference to certain embodiments thereof, it is apparent for those skilled in the art that various changes and modifications may be made therein without departing from the spirit and scope of the invention.

What is claimed is:

1. A shielded wire comprising:
a conductor;
an insulative coating provided on an outer side of the conductor;
an electrically-conductive surface treatment portion applied on a surface of the insulative coating from one end to another end, in an extending direction of the conductor, of a predetermined range on the insulative coating, the electrically-conductive surface treatment portion being configured as a shielding layer; and
an electrically-conductive member having electrical conductivity and electrically connected to the electrically-conductive surface treatment portion.

2. The shielded wire according to claim 1, wherein the electrically-conductive member is provided at a location corresponding to a bent portion of the shielded wire.

3. The shielded wire according to claim 2, wherein the electrically-conductive member comprises at least one of a wire and a tape having electrical conductivity.

4. The shielded wire according to claim 3, wherein the wire is wound spirally.

5. A wire harness comprising:
a shielded wire; and
a counterpart connection portion provided at an end of the shielded wire,
wherein the shielded wire comprises:
a conductor;
an insulative coating provided on an outer side of the conductor;
an electrically-conductive surface treatment portion applied on a surface of the insulative coating from one end to another end, in an extending direction of the conductor, of a predetermined range on the insulative coating, the electrically-conductive surface treatment portion being configured as a shielding layer; and
an electrically-conductive member having electrical conductivity and electrically connected to the electrically-conductive surface treatment portion, and
wherein the counterpart connection portion is electrically connected to the electrically-conductive surface treatment portion.
